(19) United States
(12) Patent Application Publication
(10) Pub. No.: US 2011/0057788 A1
(43) Pub. Date: Mar. 10, 2011

(54) Apparatus and Method For Determining Tampering With A Movable Barrier

(76) Inventors: Thomas More Talkington, Tempe, AZ (US); Daniel Marvin Vincent, Phoenix, AZ (US)

(21) Appl. No.: 12/557,067

(22) Filed: Sep. 10, 2009

(51) Int. Cl. G08B 19/00; G08B 13/00

(52) U.S. Cl. 340/521; 340/550; 340/551

(57) ABSTRACT

A tampering detection apparatus is used to determine the occurrence of unauthorized tampering with a barrier. At a tampering detection apparatus, a quantity during an operation of the movable barrier is sensed without actuating a magnetic switch. The quantity is potentially indicative of unauthorized tampering with the movable barrier. A determination is made as to whether the quantity is within a valid operating range. When the quantity is not within the valid operating range, a warning is issued to a user. The warning indicates a potential tampering with the movable barrier.

### FIELD OF THE INVENTION

The field of the invention relates to movable barrier operator systems and, more specifically, to detecting tampering with barriers in these systems.

### BACKGROUND

Various types of barriers are used to secure the contents of different areas. For example, movable barriers of various kinds are used to protect the contents of homes, self-storage areas, businesses, and industrial sites.

In the case of self-storage units, an individual typically secures the door of their unit by using a padlock or other type of locking arrangement. Unfortunately, unauthorized individuals sometimes attempt to tamper with the door/lock and gain entry into the unit. The unauthorized individual may be unconnected with the owner of the self-storage unit (e.g., he or she may be another renter) or the unauthorized individual may sometimes be an employee who wants to gain entry to the self-storage unit to steal some or all of its contents. In any event, occurrences of unauthorized tampering with doors in self-storage units (along with thefts associated with the tampering) have increased in recent years.

In an attempt to solve the problem of unauthorized tampering with movable barriers associated with self-storage units and in other locations, various barrier monitoring devices have been devised. For example, one previous approach uses a Reed magnetic switch and a magnet to detect tampering. When the Reed switch is aligned near the magnet, the Reed switch is closed, and it is assumed that no tampering is occurring with respect to the barrier. However, if an unauthorized attempt is made to open the door, the Reed switch opens (due to the device not being in the presence of the magnetic field) and the switch opens. The opening of the switch indicates possible tampering with the door and, in this situation, the proper authorities can be alerted that a potential security problem exists with respect to the area protected by the movable barrier.

Unfortunately, enterprising criminals have found ways to spoof Reed switches used in barrier monitoring systems, open the barrier, and gain access to protected areas. Reed switches are typically sensitive to magnetic fields and can be opened and closed easily and quickly with only a small amount of magnetic field being required to actuate the switch. Consequently, criminals sometimes have applied a supplemental magnetic field and maintained the Reed switch in a closed position even while opening the barrier. In so doing, the criminal could then open the barrier, gain entry into the protected area, and steal the contents of the protected area. As a result, the use of a magnetic switch such as the Reed switch in barrier monitoring systems has failed to adequately secure the areas protected by these devices.

### SUMMARY

Approaches are provided to determine whether tampering with a barrier is occurring and these approaches do not use magnetic switches. As used herein, the expression “magnetic switch” will be understood to refer to an electrical switch that can make and break an electrical connection in direct response to the presence and absence of a magnetic field. The approaches described herein are not easily susceptible to tampering since the use of a sensitive and easily actuated magnetic switch is omitted. The approaches are also easy and cost effective to implement and can be used in conjunction with a wide variety of barriers that secure a wide variety of different spaces and areas.

In many of these embodiments, a tampering detection apparatus is used to determine the occurrence of unauthorized tampering with a barrier. At the tampering detection apparatus, a quantity is sensed during an operation of the movable barrier and the sensing is accomplished without actuating or using a magnetic switch. The sensed quantity is potentially indicative of unauthorized tampering with the movable bather. A determination is made as to whether the quantity is within a valid operating range. When the quantity is not within the valid operating range, a warning is issued to a user. For example, a warning may be sent directly to a user or to an alarm center. The warning indicates potential tampering with the movable barrier.

In many of these examples, the sensing is accomplished using a dedicated sensor that indicates a presence of a sensed object such that the sensor and the sensed object are located adjacent to each other when the barrier is in a first state and are separated by at least some predetermined distance when the barrier is in a second state. In one example, the first state occurs when the barrier is closed and the second state occurs when the barrier is open. Other examples are possible.

The quantities sensed by the sensor may be a variety of different quantities representative of many different phenomena. For instance, the sensed quantity may be a change in magnetic field, Radio-Frequency Identification (RFID) information, or an acceleration to name a few examples.

In the case where the sensed information is RFID information, the RFID information may be obtained from an RFID tag. In one approach, a determination may be made as to whether the RFID information comprises a valid value. In another example, a determination can be made as to whether any RFID information has been sensed (rather than the content of such information).

When a change in magnetic field is detected, this may be accomplished using a Hall effect sensor (which, though sensitive to the presence and absence of a magnetic field, is itself not a magnetic switch). In this case, it may be determined whether a particular change in magnitude or the absolute magnitude are acceptable. When the change in magnitude or the absolute magnitude are not acceptable, then an alarm condition may be activated.

When acceleration is measured, an accelerometer may be used. When an accelerometer is used, it may then be determined whether the acceleration is within a valid acceleration range and if not an alarm condition can be activated.

The operation of the movable barrier that is associated with the measured quantity may be a number of different operations such as opening the movable barrier, closing the movable barrier, or maintaining the movable barrier in a stationary position. Other examples of barrier movement are possible.

In others of these embodiments, an apparatus for determining potential unauthorized tampering with a movable barrier includes a sensor apparatus, an interface, and a detector. The sensor apparatus does not include a magnetic switch and is configured to sense a quantity during an operation of the movable barrier. The sensed quantity is potentially indicative of unauthorized tampering with the movable barrier.

The interface has an input that is in communication with the sensor apparatus and receives the sensed quantity from the sensor apparatus. The interface further includes an output. The output may communicate with a user. As used herein, the expression “user” will be understood to an end user of the protected facilities, a party authorized or charged to protect the facilities (such as an on-site custodian or manager or an off-site alarm center), and so forth.

The detector is coupled to the interface and is configured to determine whether the sensed quantity received via the input of the interface is within a valid operating range. When the sensed quantity is not within the valid operating range, the detector is configured to issue a warning at the output of the interface to a user. The warning indicates potential tampering with the movable barrier. The detector may include a processing device such as a microprocessor or the like. Further, the detector may include a memory where valid operating ranges of the sensed values are stored.

In some examples, the sensor apparatus comprises a first portion and a second portion and the first portion is disposed at the barrier (to thereby move with the barrier) and the second portion is stationary with respect to the barrier. In other examples, the sensor apparatus may be disposed entirely on the door or entirely in a stationary position (e.g., the door frame). In addition, other parts of the apparatus may be disposed at different locations.

The quantities sensed by the sensing device may be a variety of different quantities. For example, the sensing apparatus may sense a change in a magnetic field, Radio-Frequency Identification (RFID) information, or an acceleration of the barrier to name a few examples. With such examples in mind, the sensor apparatus may, for example, be a Hall effect sensor, an RFID reader, or an accelerometer.

Thus, approaches are provided where the movement of barriers is sensed and tampering is detected without the use of magnetic switches. The approaches described herein are not readily susceptible to tampering and are easy and cost effective to implement.

### BRIEF DESCRIPTION OF THE DRAWINGS

FIG. 1 comprises a block diagram of a system for determining tampering with a movable barrier according to various embodiments the present invention;

FIGS. 2A and 2B comprise block diagrams of one example of a tampering detection system using RFID devices according to various embodiments of the present invention;

FIGS. 3A and 3B comprise block diagrams of one example of a tampering detection system using magnetic sensors according to various embodiments of the present invention;

FIG. 4 comprises a block diagram of a tampering detection apparatus according to various embodiments of the present invention; and

FIG. 5 comprises a flowchart showing one example of the operation of a tampering detection system according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DESCRIPTION

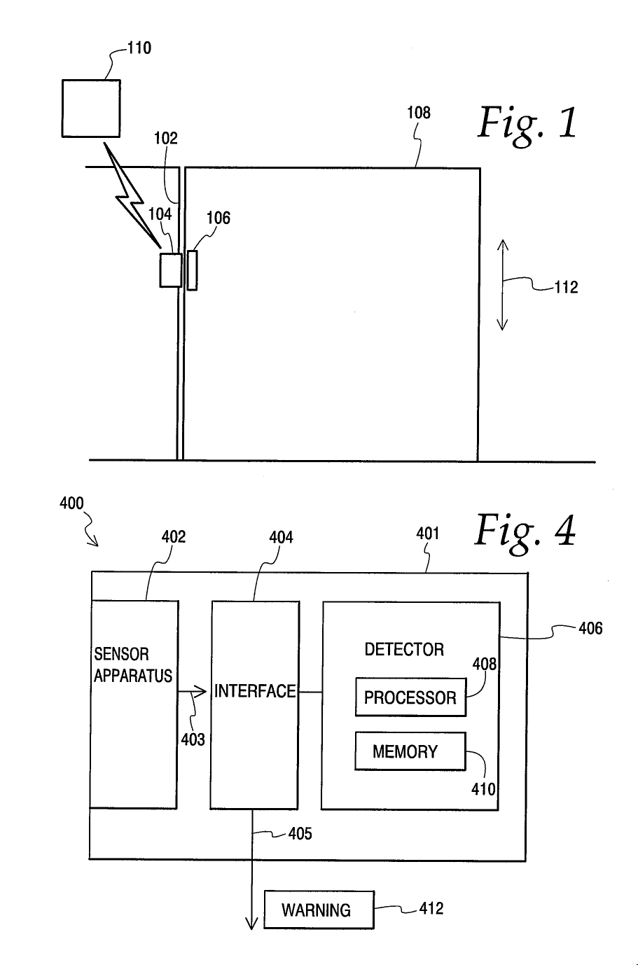

Referring now to FIG. 1, one example of a system that determines the existence of tampering with respect to a moveable barrier is described. A tampering detection apparatus 104 interacts with an optional phenomena-producing device 106. The tampering detection apparatus 104 is coupled to a door frame 102 and the device 106 is coupled to a movable barrier 108 that moves upward and downward in directions indicated by an arrow labeled 112.

The tampering detection apparatus 104 may communicate with an alarm reception apparatus 110. The communication may occur along any wired or wireless communication link that operates according to any communication protocol of choice. The alarm reception apparatus 110 is configured to receive the alarm (indicating potential tampering with the barrier 108) and take an appropriate action (or communicate the alarm to another device where appropriate action can be taken). For example, the alarm reception apparatus may be an external alarm center that manually or automatically dispatches police or other appropriate security personnel to investigate potential tampering with the barrier 108. In other examples, the alarm reception device 110 may be a movable barrier operator that itself communicates with an external alarm or security center. In still other examples, visible or audible indicators (not shown) may be coupled to the tampering detection apparatus 104. For examples, sirens and/or lights may be employed and activated when tampering is detected to dissuade criminals from further tampering with the barrier 108.

The device 106 is optionally used to produce some measureable phenomena that is detected by the tampering detection apparatus 104. For example, the device 106 may be an RFID tag (including either a passive RFID tag or an active RFID tag as both are known in the art), a magnet (including either one or more permanent magnets and/or one or more electromagnets as are also well known in the art), and/or a lighting element (e.g., optical eyes with infrared elements or light emitting diodes (LEDs)), to name a few examples. As explained herein, the absence of detection of the particular phenomena (or the detection of invalid informational content carried by the phenomena) causes the tampering detection apparatus 104 to determine that tampering is occurring with the barrier 108. In other examples, the phenomena-producing device 106 may be omitted since the tampering detection apparatus 104 directly measures a phenomena that is associated with the barrier 108 (e.g., the apparatus 104 measures the speed of barrier movement or barrier acceleration). It will be appreciated that the placement of the phenomena producing device 106 and the tampering detection apparatus may vary. For example, when the apparatus 104 is or includes an accelerometer, this device may be disposed on or at the barrier, at a stationary location (e.g., at the door frame), or split between different locations.

As mentioned, the tampering detection apparatus 104 determines the occurrence of unauthorized tampering with the barrier 108 in some examples by detecting a phenomena associated with the device 106. In this respect, the tampering detection apparatus 104 may include sensors and a programmed processing device to determine from the signals received from the sensors whether tampering has occurred. The sensors used may sense any sensible phenomena including but not limited to magnetic fields, Radio-Frequency Identification (RFID) information, and acceleration, provided that the structure that is used to sense to the phenomena does not include a magnetic switch. In some particular examples, such a sensor may be a Hall effect sensor (to detect a magnetic field from the device 106), an RFID sensor (to detect RFID information produced by the device 106), or an accelerometer (to measure the acceleration of the movable barrier 108). Other examples of sensor or sensor structures are possible.

The moveable barrier 108 may be any type of barrier that is configured to selectively move in order to provide authorized access. For example, the movable barrier 108 may be a garage door, a swinging gate or arm, a sliding gate, rolling shutters, or a swinging door. Other examples of barriers are possible.

Although the tampering detection apparatus 104 is shown in FIG. 1 as being housed within a single housing unit, it will be appreciated that the functions and components of the tampering detection apparatus 104 may be distributed amongst more than one physical housing unit and these housing units may be placed at multiple locations. For example, sensors of the tampering detection apparatus 104 may be disposed in a first housing unit and disposed at a first location while the processing functions of the tampering detection apparatus (e.g., a microprocessor) may be disposed in a second housing unit and positioned at a second location. In other examples, some portions of the sensors may be disposed in a first position (e.g., on the door frame) while other portions of the sensors may be disposed at another location (e.g., on the barrier).

As mentioned herein, it will be appreciated that in other examples the use of the phenomena-producing device 106 may be omitted. For example, in the case where the tampering detection apparatus 104 includes an accelerometer, there is no need to employ the device 106 since the tampering detection apparatus 104 measures the acceleration of the barrier 108 itself. In such cases, there is no need to provide a supplemental phenomena to support the described purposes.

In one example of the operation of the system of FIG. 1, the tampering detection apparatus 104 senses a quantity during an operation of the movable barrier without actuating a magnetic switch. The quantity is indicative of potentially-unauthorized tampering with the movable barrier 108. A determination is made as to whether the quantity is within a valid operating range. When the quantity is not within the valid operating range, a warning is issued to a user. The warning indicates a potential tampering with the movable barrier 108.

In many of these examples, the tampering detection apparatus 104 uses a dedicated sensor that indicates a presence of a sensed object (e.g., an RFID tag or magnet) such that the sensor and the sensed object are located adjacent to the sensor when the barrier is in a first state and are separated when the barrier 108 is in a second state. In one example, the first state is when the barrier 108 is closed and the second state is when the barrier 108 is not closed (as when the barrier 108 is fully or partially opened). Other examples are possible.

In the case where the sensed phenomena is a signal that indicates RFID information, the RFID information may be obtained from an RFID tag. A determination may be made as to whether the RFID information comprises valid content (such as a valid alphanumeric string, numerical value, or the like). In another example, a determination can be made as to whether any RFID information has been sensed (without specific regard for the substantive content of that information) and if no information is sensed, an alarm condition can be actuated.

When a change in magnetic field is to be detected, this detection may be accomplished using a Hall effect sensor. In this case, it may be determined if the change in magnitude or the absolute magnitude of the sensed magnetic field are acceptable, and if not an alarm may be issued. When acceleration is the quantity to be measured, an accelerometer may be used. It may then be determined as to whether the sensed acceleration is within a valid acceleration range. As noted earlier, a prior art magnetic switch-based approach can be spoofed by an unauthorized person who simply substitutes an additional magnetic to maintain the magnetic switch in a given state while manipulating the barrier in an unauthorized manner. The use of a Hall effect sensor, however, is not necessarily subject to such easily-effected spoofing. In particular, the Hall effect sensor can be used to determine not only the presence of a magnetic field, but the relative strength of that field. Using a supplemental magnet to try and spoof such a system therefore becomes considerably more difficult as the unauthorized person must manage to constantly match, over time, the strength of the original field.

The sensing ranges of the various sensors that are adjacently placed to the sensed objects may also vary. For example, when RFID tags are used, the read range (i.e., maximum distance from a sensor to the tag) of the passive tags depends upon various factors such as the frequency of operation, the amount of power of the tag reader, the amount of electromagnetic interference from other RF devices and so forth. Generally speaking, low frequency tags (e.g., 9-135 KHz) are read from approximately one foot (0.33 meters) or less. High frequency tags (e.g., 13.553-15.567 MHz) are generally read from about three feet (1 meter) and UHF tags (e.g., 860-930 MHz) are read from 10 to 20 feet. Where longer sensing ranges are needed, active tag batteries are used to boost read ranges to approximately 300 feet (100 meters) or more.

When magnetic sensors are used, the read range (maximum distance from the sensor to the magnet) may vary from a few inches to several feet. These ranges may vary depending upon the type of magnets used, the strength of the magnets, and electromagnetic interference, to name a few factors. When an accelerometer is used, the accelerometer may be placed, for example, on the door frame within a variable range of a few inches to many feet of the door. When infrared (IR) or light emitting diode (LED) sensors are used, transmitters and receivers may be placed directly across from each other and have a vertical displacement as to each other of a few inches to give one example. The horizontal distance between the transmitter and receiver may range from a few inches to many feet (e.g., the distance of the barrier opening). Both the vertical and horizontal distance may be affected and be varied according to factors such as the type of sensor used and the power of the transmitter. It will be appreciated that the ranges between sensors and sensed objects mentioned here are examples only and may be varied according to the needs of the user or the system.

The operation of the movable barrier that is associated with measured quantity may be a number of different operations such as the opening of the movable barrier, the closing of the movable barrier, or maintaining the movable barrier in a stationary position. Other examples of barrier operations/movement are possible.

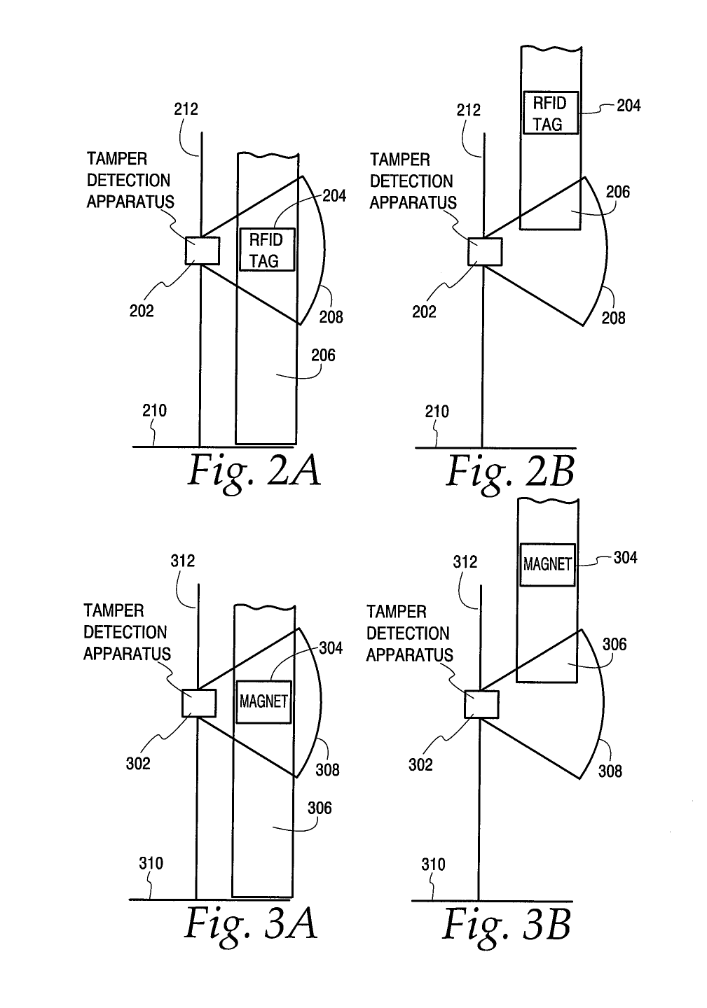

Referring now to FIGS. 2A and 2B, one example of using a tampering detection apparatus that includes an RFID tag is described. A tampering detection apparatus 202 is disposed on a door frame 212. Alternatively, the tampering detection apparatus 202 may be disposed at the door. A barrier 206 (which, in this illustrative non-limited example, comprises a garage door), moves upward to an open position and downward to a closed position and in the fully-closed position rests on the ground 210. An RFID tag 204 is disposed on the barrier 206. Alternatively, the tag 204 may be disposed on the door frame. The tag 204 may be coupled to the door with any appropriate fastening mechanism. The tampering detection apparatus 202 includes an RFID sensor that has a sensing range 208. That is, the RFID sensor is capable of sensing RFID information from the RFID tag 204 when the RFID tag 204 is within the sensing range 208 but is not capable of reliably detecting information from the RFID tag 204 when the RFID tag 204 is outside of the sensing range 208. As discussed above, the sensing range 208 may vary from a few inches (e.g., around an inch) to many feet (e.g., 10 feet or more). Other ranges are possible.

In FIG. 2A, the RFID tag 204 is shown as being within the sensing range 208. In this case, the tampering detection apparatus 202 can read the RFID information and conclude that no tampering with the barrier 206 is occurring (provided, for example, the RFID information sensed is determined to be valid). In FIG. 2B, however, the RFID tag 204 has moved out of the sensing range 208. In this case, the tampering detection apparatus can not read the RFID information and determines that tampering with the barrier 206 is occurring.

In other examples, a criminal may attempt to use an imposter RFID tag and use the false RFID information (from the imposter RFID tag) to prevent the generation of an alarm condition. However, in the present example, the tampering detection apparatus may store known valid RFID information and compare this to the false information that is sensed. Consequently, tampering is detected, an alarm message may be sent, and appropriate actions (e.g., dispatch of the police or other security personnel) taken to prevent the tampering or theft of the contents of a protected area. If desired, and as may be appropriate when employing an active RFID tag having onboard powered processing capabilities, further precautions such an occasionally-changing rolling code can be used to further uniquely pair the valid RFID tag with the sensor.

When using RFID tags, it may be useful to strobe or otherwise read the RFID tag on a periodic basis. For example, the sensor may read the tag every 0.1 seconds, every second, or such other period of time as may be suitable to a given application setting.

Referring now to FIGS. 3A and 3B, one example of using a tampering detection apparatus with magnets is described. A tampering detection apparatus 302 is disposed on a door frame 312. A barrier 306 (again in this non-limiting example a garage door), moves upward to an open position and downward to a closed position and in the fully-closed position rests on the ground 310. One or more magnets 304 are disposed on the barrier 306. The tampering detection apparatus 302 includes a Hall effect sensor that has a sensing range 308. That is, the Hall effect sensor is capable of sensing the particular magnetic field produced by the magnets 304 when the magnets 304 are within the range 308 but is not capable of detecting this magnet field when the magnets 304 are outside of the range 308. In the alternative, this Hall effect sensor may sense the strength of the magnetic field as corresponds to the magnets 304 as the magnets 304 are moved closer to or away from the sensor. In such a case, the Hall effect sensor will sense a weakening field as the magnets 304 move away from the sensor and a maximum-strength magnetic field when the magnets 304 are positioned immediately adjacent the sensor. As discussed above, the sensing range 308 may vary from a few inches (e.g., around an inch) to many feet (e.g., 10 feet or more). Other ranges are possible.

In FIG. 3A, the magnets 304 (and their magnetic field) are shown to be within the aforementioned range 308. In this case, the tampering detection device can read the field and determine that no tampering with the barrier 306 is occurring (or, in the alternative, can be used to measure that the magnetic field is at its maximum). In FIG. 3B, however, the magnets 304 (and their magnetic field) have moved out of the range 308. In this case, the tampering detection apparatus 304 can not read any field (or reads a minimal field value) and determines that tampering with the barrier 306 is occurring (e.g., if the reduction in magnetic field strength is above a predetermined value).

In other examples, a criminal may attempt to use an imposter magnet to fool the tampering detection apparatus 302 into believing the barrier is in the closed position and open the barrier using the presence of the false field from the imposter magnet to prevent generation of an alarm condition. However, in the present example, the tampering detection apparatus may compare the field information to known valid and good field information. The false field will typically be different is some respect (e.g., the magnitude and/or direction will be different either in value or over time) from the expected and valid field. Consequently, tampering is detected, an alarm message may be sent, and appropriate actions (e.g., dispatch of the police or other security personnel) are taken to prevent the tampering.

Referring now to FIG. 4, one example of a tampering detection apparatus 400 is described. The tampering detection apparatus 400 includes a sensor apparatus 402, an interface 404, and a detector 406. These components are disposed within a housing 401. The sensor apparatus 402 does not include a magnetic switch and is configured to sense a quantity during an operation of a movable barrier. The quantity is potentially indicative of unauthorized tampering with the movable barrier.

The interface 404 has an input 403 in communication with the sensor apparatus 402 and receives the sensed quantity from the sensor apparatus. The interface 402 further includes an output 405 by which a warning or alarm message 412 can be issued when tampering with the barrier is determined.

The detector 406 is coupled to the interface 404 and is configured to determine whether the sensed quantity received via the input 403 of the interface 404 is within a valid operating range. The detector 406 is configured to, when the sensed quantity is not within the valid operating range, issue the warning 412 at the output 405 of the interface 404 to a user or an alarm center. The warning 412 indicates potential tampering with the movable barrier.

In this example, the detector 404 includes a processing device 408 such as a microprocessor or the like. It will be appreciated that various analog components may be used in addition to or in place of the processing device 408. The detector 404 also includes a memory 410. The memory 410 may store known valid information (e.g., known good RFID information, known valid field magnitude information, or known valid accelerations) and the processor 408 may compare this against information obtained by the sensor apparatus 402 to determine if tampering is occurring.

In some examples, the sensor apparatus 402 comprises a first portion and a second portion and the first portion is disposed at the barrier and the second portion is stationary. In other examples, the sensor apparatus 402 may be disposed entirely (with the other components of the tampering detection apparatus 400) on the door or positioned entirely at a stationary location (e.g., the door frame).

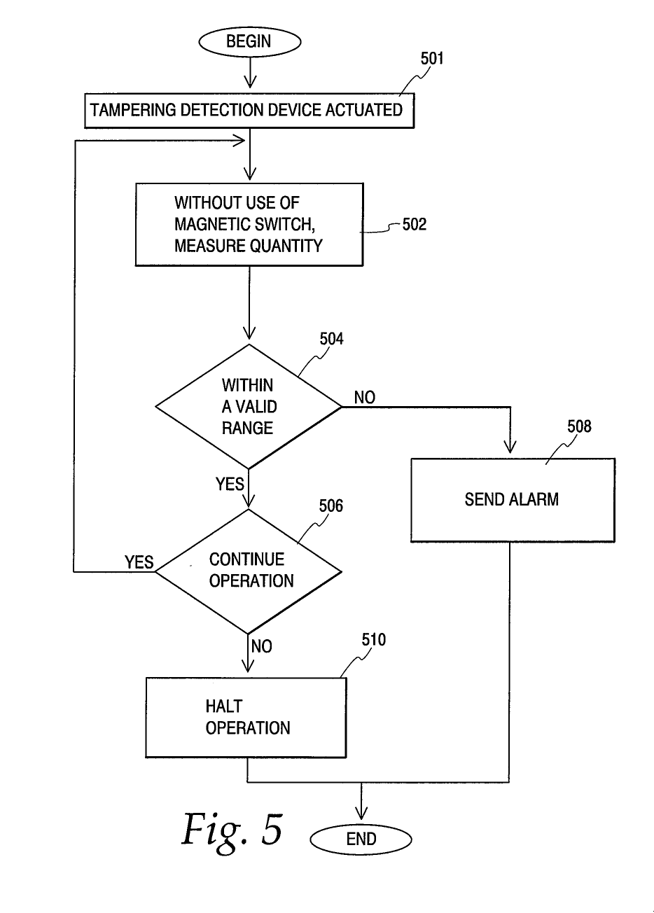

Referring now to FIG. 5, one example of an approach for determining the occurrence of tampering with a barrier is described. At step 501, the tampering detection apparatus is activated. For example, a person may lock a barrier and activate the tampering detection apparatus. In other examples, the user may move a switch or other actuator to activate the tampering detection apparatus. If desired, arming of the tampering detection apparatus may also comprise an automated step.

At step 502 a quantity is sensed during an operation of the movable barrier without actuating a magnetic switch. That is to say, no magnetic switch is actuated to effect this step; these teachings will of course tolerate a magnetic switch being contemporaneously used to effect some other purpose, action, or functionality. For example, a magnetic switch might be utilized to detect movement of the barrier and cause a help light to become illuminated. The quantity is potentially indicative of unauthorized tampering with the movable barrier. The quantities sensed by the sensor may be a variety of different quantities representative or indicative of many different phenomena. For instance, the sensed quantity may indicative of a change in magnetic field, Radio-Frequency Identification (RFID) information, or may represent an acceleration to name a few examples.

At step 504, a determination is made as to whether the quantity is within a valid operating range. When the quantity is not within the valid operating range, a warning or alarm is issued to a user at step 508. The warning indicates a potential tampering with the movable barrier. In one example, the quantity may be an acceleration of the barrier and it may be determined if the acceleration is exceeded. In another example, the quantity may be an change in magnetic field strength over a time period, and it may be determined if this value is exceeded. In still another example, the quantity may be RFID tag identification information and it may be determined if this information matches identifiers of known and valid RFID tags. Other examples of quantities and comparisons are possible.

When the answer at step 504 is affirmative, execution continues at step 506 where it is determined whether to continue operation of the tampering detection system. For example, a user may unlock the door and deactivate the system by actuating a switch. In other examples, unlocking the door may automatically deactivate the system. If the answer at step 506 is affirmative, then control continues at step 502 as described above. If the answer at step 506 is negative, at step 510 operation of the tampering detection system is halted.

Thus, approaches are provided that determine when barrier tampering occurs and these approaches do not use magnetic switches. The approaches described herein are not easily susceptible to existing tampering methodologies since the use of a magnetic switch is omitted. The approaches are also easy and cost effective to implement and can be used with a wide variety of barriers that secure a wide variety of different spaces or areas.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of determining potential unauthorized tampering with a movable barrier, the method comprising:
at a tampering detection apparatus:
without actuating a magnetic switch, sensing a quantity during an operation of the movable barrier, the quantity being potentially indicative of unauthorized tampering with the movable barrier;
determining whether the quantity is within a valid operating range;
when the quantity is not within the valid operating range, issuing a warning to a user, the warning indicating a potential tampering with the movable barrier.

2. The method of claim 1 wherein the sensing is provided by a sensor and indicates a presence of a sensed object such that the sensor and the sensed object are located adjacent to each other when the barrier is in a first state and are separated when the barrier is in a second state.

3. The method of claim 1 wherein the quantity is a value selected from the group consisting of a change in magnetic field, Radiofrequency Identification (RFID) information, and an acceleration.

4. The method of claim 1 wherein the operation of the movable barrier comprises an actuation selected from the group consisting of opening the movable barrier, closing the movable barrier, and maintaining the movable barrier in a stationary position.

5. The method of claim 1 wherein sensing a quantity comprises reading a signal indicative of Radiofrequency Identification (RFID) information from an RFID tag.

6. The method of claim 5 wherein determining whether the quantity is within a valid operating range comprises determining whether the RFID information comprises a valid value.

7. The method of claim 5 wherein determining whether the quantity is within a valid operating range comprises determining whether any RFID information has been sensed.

8. The method of claim 1 wherein measuring a quantity comprises measuring a change in a magnetic field produced by a magnet.

9. The method of claim 8 wherein the measuring a change in a magnetic field is accomplished using a Hall effect sensor.

10. The method of claim 1 wherein measuring a quantity comprises measuring an acceleration of the movable barrier.

11. The method of claim 10 wherein determining whether the quantity is within a valid operating range comprises determining whether the acceleration is within a valid acceleration range.

12. An apparatus for determining potential unauthorized tampering with a movable barrier, the apparatus comprising:
a sensor apparatus that does not include a magnetic switch, the sensor apparatus being configured to sense a quantity during an operation of a movable barrier, the quantity being potentially indicative of unauthorized tampering with the movable barrier;
an interface, the interface having an input in communication with the sensor apparatus and receiving the sensed quantity from the sensor apparatus, the interface further including an output;
a detector coupled to the interface, the detector configured to determine whether the sensed quantity received via the input of the interface is within a valid operating range, the detector is further configured to, when the sensed quantity is not within the valid operating range, issue a warning at the output of the interface to a user, the warning indicating potential tampering with the movable barrier.

13. The apparatus of claim 12 wherein the sensor apparatus comprises a first portion and a second portion and the first portion is disposed at the barrier and the second portion is stationary.

14. The apparatus of claim 12 wherein the detector comprises a processing device.

15. The apparatus of claim 12 wherein the quantity is a value selected from the group consisting of a change in magnetic field, Radiofrequency Identification (RFID) information, and an acceleration.

16. The apparatus of claim 12 wherein operation of the movable barrier comprises an actuation selected from the group consisting of opening the movable barrier, closing the movable barrier, and maintaining the movable barrier in a stationary position.

17. The apparatus of claim 12 wherein the detector is configured to read a signal indicative of Radiofrequency Identification (RFID) information from an RFID tag.

18. The apparatus of claim 17 wherein the detector is further configured to determine whether the RFID information is a valid value.

19. The apparatus of claim 17 wherein the detector is further configured to determine whether any RFID information has been sensed.

20. The apparatus of claim 12 wherein the sensor apparatus is configured to measure a change in a magnetic field produced by a magnet attached to the movable barrier.

21. The apparatus of claim 20 wherein the sensor apparatus comprises a Hall effect sensor.

22. The apparatus of claim 12 wherein the sensor apparatus comprises an accelerometer that is configured to measure an acceleration of the movable barrier.

23. The apparatus of claim 22 wherein the detector is configured to determine whether the acceleration is within a valid acceleration range.

24. An apparatus of determining potential unauthorized tampering with a movable barrier, the method comprising:
means for sensing a quantity during an operation of the movable barrier, the quantity being potentially indicative of unauthorized tampering with the movable barrier;
means for determining whether the quantity is within a valid operating range;
means for issuing a warning to a user when the quantity is not within the valid operating range, the warning indicating a potential tampering with the movable barrier.

25. The apparatus of claim 24 wherein the means for sensing a quantity comprises a Radiofrequency Identification (RFID) sensor.

26. The apparatus of claim 24 wherein the means for sensing a quantity comprises a magnetic field sensor.

27. The apparatus of claim 24 wherein the means for sensing a quantity comprises an accelerometer.
